(19) United States
(12) Patent Application Publication
(10) Pub. No.: US 2008/0200768 A1
(43) Pub. Date: Aug. 21, 2008

(54) Equine dental speculum

(76) Inventor: R. Scott Capps, Clatonia, NE (US)

Correspondence Address: Law Offices of Adam H. Jacobs;Adam H. Jacobs, Suite 726, 1904 Farnam Street, Omaha, NE, 68102, US

(21) Appl. No.: 11/708,828

(22) Filed: Feb. 21, 2007

(51) Int. Cl. A61D 15/00

(52) U.S. Cl. 600/244

(57) ABSTRACT

A improved equine dental speculum includes upper and lower frames pivotably connected to one another, upper and lower jaw and teeth engagement bars mounted on respective ones of the upper and lower frames which fit in the horse's mouth, frame spacing bars extending between and connecting the frame and the frame spacing securement devices which each include a slide stop assembly movably mounted on the frame arm which includes a movably mounted carriage and a stop bar adjustably mounted thereon, the stop bar having a frame arm slot extending transversely therethrough and having dimensions slightly larger than the cross-sectional dimensions of the frame arm and through which the frame arm extends to releasably frictionally engage the frame arm so that the upper and lower frames will open along with the horse's mouth yet prevent the horse from closing its mouth until the stop bar is released.

### BACKGROUND OF THE INVENTION

1. Technical Field

The present invention is directed to dental devices for animals and, more particularly, to an equine dental speculum which includes upper and lower frames pivotably connected to one another at the rear thereof, the frames each including upper and lower jaw and teeth engagement bars extending across and connecting the front portions thereof with their being designed to fit within a horse's mouth, at least one set of securement straps for securing the speculum on a horse, and at least one frame spacing securement device which includes a slide stop assembly movably mounted on the upper frame and a frame spacing bar pivotably mounted on the lower frame and connected to the slide stop assembly, the slide stop assembly operative to frictionally engage the upper frame via a stop bar such that as the upper and lower frames are pivoted away from one another, the frame spacing securement device prevents the upper and lower frames from pivoting towards one another via the frictional contact between the stop bar and the upper frame until the stop bar is pivoted to release the frictional contact between the stop bar and the upper frame, thus providing a continuously and infinitely adjustable frame spacing system by which large or small mouth opening movements of the horse are accommodated and secured by the operation of the present invention.

2. Description of the Prior Art

A veterinary dental speculum is generally utilized to hold the mouth of an animal, such as a horse, open while dental and/or medical attention is given to the animal. The dental speculum is designed to prevent the animal from closing its mouth when the veterinarian or care giver is attempting to work on the interior of the animal's mouth.

Many different types of veterinary dental speculums are shown in the prior art, including such devices as Meister, U.S. Pat. No. 5,704,901, Berzina, U.S. Pat. No. 2,096,083, Stubbs, U.S. Pat. No. 5,718,665, and Jeffrey, et al., U.S. Pat. No. 6,695,776. Each of these prior art devices is designed to address and solve the problem encountered in dealing with large animals such as horses, and that is specifically that these animals do not generally consent to a person inserting hands, tools, etc., into their mouths without some type of restraint being utilized to prevent the animal from closing their mouth. It should be noted, however, that each of the prior art devices cited includes an adjustment device which includes a ratchet or screw by which the distance between the sections of the speculum may be adjusted and secured. The significant problem with the use of such ratchets and screws is that they do not provide continuous infinite adjustment of the distance between the upper and lower frames of the dental speculums, which means that if the user of one of the devices found in the prior art is unable to get the animal to open its mouth a sufficient distance to enable the device to ratchet to the next setting, the user is unable to effectively take what mouth opening movements the animal is giving him or her and slowly and steadily move and retain the mouth in an open position. There is therefore a need for an equine dental speculum which incorporates this continuous infinite adjustment of the spacing between the upper and lower frames of the speculum and would do so in a manner which does not require the user to manually adjust or operate elements or devices to take advantage of the measured opening of the animal's mouth.

Therefore, an object of the present invention is to provide an improved equine dental speculum.

Another object of the present invention is to provide an improved equine dental speculum which includes upper and lower frames pivotably connected to one another at the rear thereof, upper and lower jaw and teeth engagement bars which engage the teeth and jaw of the horse, and at least one frame spacing securement device which provides infinite adjustment and retention of spacing between the upper and lower frames within the range of which the horse may open its mouth.

Another object of the present invention is to provide an improved equine dental speculum in which the frame spacing securement device includes a slide stop assembly movably mounted on the upper or lower frame, a frame spacing bar pivotably mounted on the opposite one of the upper and lower frame and connected to the slide stop assembly, the slide stop assembly further including a stop bar adjustment mounted on the side stop assembly carriage, the stop bar including a frame arm slot through which the frame arm extends such that the stop bar frictionally engages the frame arm to permit rearward sliding of the slide stop assembly yet prevent forward sliding on the frame arm as the upper and lower frames are pivoted away from each other.

Another object of the present invention is to provide an improved equine dental speculum which will safely and comfortably secure a horse's mouth in an open position and will do so without requiring manual adjustment of ratchets or screws to secure the speculum in its extended or open position.

Another object of the present invention is to provide an improved equine dental speculum which does not include spacing securement devices which generate significant amounts of noise so as to eliminate a potentially upsetting external stimulus which could result in the further startling or spooking of the horse, who is likely already nervous or frightened due to the circumstances of use of the present invention.

Finally, an object of the present invention is to provide an improved equine dental speculum which is relatively simple and durable in design and construction and is safe, efficient, and effective in use.

### SUMMARY OF THE INVENTION

The present invention provides an improved equine dental speculum which includes an upper frame having left and right upper frame arms each including a forward end, a rearward end, and a middle section, and a lower frame having left and right lower frame arms each including a forward end, a rearward end, and a middle section. A pair of pivot joints pivotably join the upper and lower frames at the rearward ends of the respective adjacent left and right frame arms and upper and lower jaw and teeth engagement bars each having incisor engagement sections extend between and releasably connect the forward ends of the left and right upper frame arms and left and right lower frame arms respectively. At least one set of the securement straps is mounted on the equine dental speculum for releasably securing the speculum on a horse and most importantly at least one frame spacing securement device is mounted on the equine dental speculum, the frame spacing securement device including a slide stop assembly movably mounted on the middle section of one of the left and right upper and left and right lower frame arms, the slide stop assembly including a movably mounted arm-engaging carriage and a stop bar adjustably mounted on the arm-engaging carriage, the stop bar having a frame arm slot extending transversely therethrough and having dimensions slightly larger than the cross-sectional dimensions of the frame arm on which the stop bar is mounted and through which the frame arm extends when the slide stop assembly is mounted thereon, the stop bar releasbly frictionally engaging the frame arm on which the slide stop assembly is mounted. A frame spacing bar extends from and is pivotably connected to the middle section of the opposite one of the left and right upper and left and right lower frame arms on the same side as the slide stop assembly such that as the upper and lower frames are pivoted apart from one another, the slide stop assembly is moved rearwards on the middle section of the frame arm on which it is mounted, and the stop bar releasbly frictionally engages the frame arm on which it is mounted to prevent the slide stop assembly from moving forwards on the frame arm thereby preventing the upper and lower frames from moving towards one another until and unless the stop bar is pivoted to release the frictional contact between the frame arm and the frame arm slot of the stop bar whereby the equine dental speculum of the present invention can be manually opened in connection with the horse's mouth being opened and the horse may not close its mouth due to the retention of the spacing between the upper and lower frames until the stop bar of the slide stop assembly is released to permit the slide stop assembly to slide forwards on the frame arm.

The improved equine dental speculum of the present invention thus provides significant advantages over those prior art devices currently being used in the equine dental field. For example, and perhaps most importantly, the slide stop assembly of the frame spacing securement device permits infinite adjustment of the spacing between the upper and lower frames of the equine dental speculum, and therefore as the horse opens its mouth, the equine dental speculum of the present invention can be manually opened to retain the mouth in the particular open position regardless of the extent to which the horse has opened its mouth. Unlike other devices found in the prior art, specifically those which include ratcheting or screw-type devices for securing the upper and lower frames in spaced-apart position, it is not necessary for the horse's mouth to be opened any particular amount corresponding to the next ratchet or screw position in order to retain the mouth in that particular open position, and therefore it is far more comfortable and less startling for the horse on whom the veterinarian or equine dental care giver is working to use the present invention than it is to use those devices found in the prior art. Furthermore, because the slide stop assembly is slidably mounted on one of the frame arms, there are fewer moving and interacting parts of the present invention than are found in those devices currently used in the prior art. This renders it less likely that mechanical failure will cause collapse of the upper and lower frames towards one another which could result in injury to the equine dental care giver utilizing the equine dental speculum. Finally, because the connection of the upper and lower jaw and teeth engagement bars to the upper and lower frames includes a pivot stop which prevents the upper and lower frame arms from pivoting towards one another beyond a pre-selected extent, it is far more comfortable for horses to be fitted with the equine dental speculum of the present invention than that encountered in fitting those devices found in the prior art. It is thus seen that the improved equine dental speculum of the present invention provides a substantial improvement over those devices found in the prior art.

### BRIEF DESCRIPTION OF THE DRAWINGS

FIG. 1 is a perspective view of the improved equine dental speculum of the present invention fitted onto a horse;

FIG. 2 is a perspective view of the improved equine dental speculum of the present invention;

FIG. 3 is a side elevational view of the present invention showing the pivoting movement of the upper frame relative to the lower frame;

FIG. 4 is a detailed perspective view of the present invention showing each of the operative elements thereof;

FIG. 5 is a detailed perspective view of the slide stop assembly and stop bar;

FIG. 6 is a detailed side elevational view of the slide stop assembly and stop bar; and

FIGS. 7 and 8 are detailed perspective and top plan views of the forward part of the speculum showing how pivoting motion of the upper and lower frames relative to the jaw and teeth engagement bars is arrested by the stop shoulder on the bars.

### DESCRIPTION OF THE PREFERRED EMBODIMENT

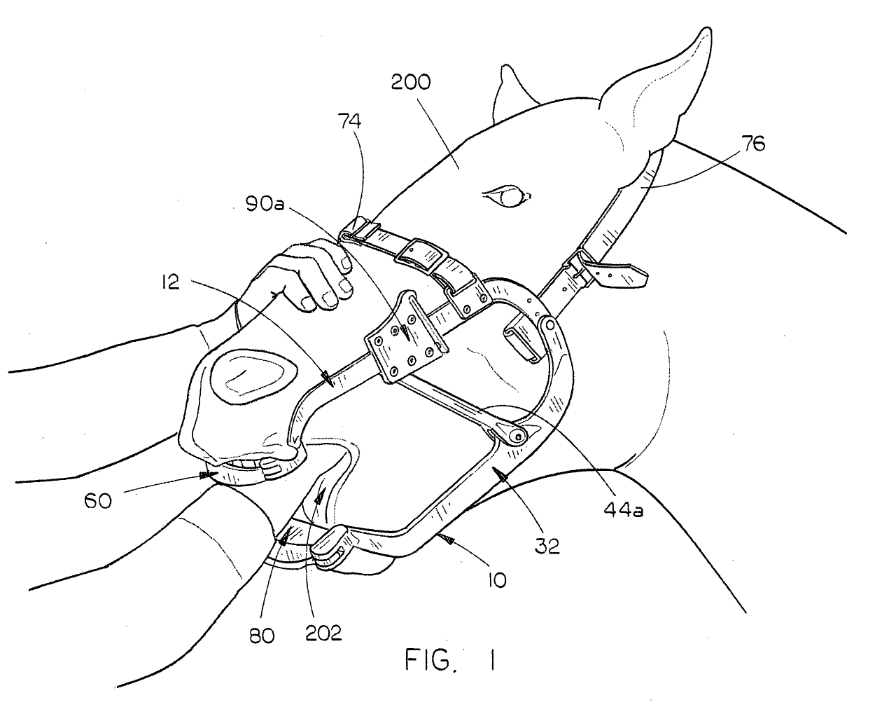

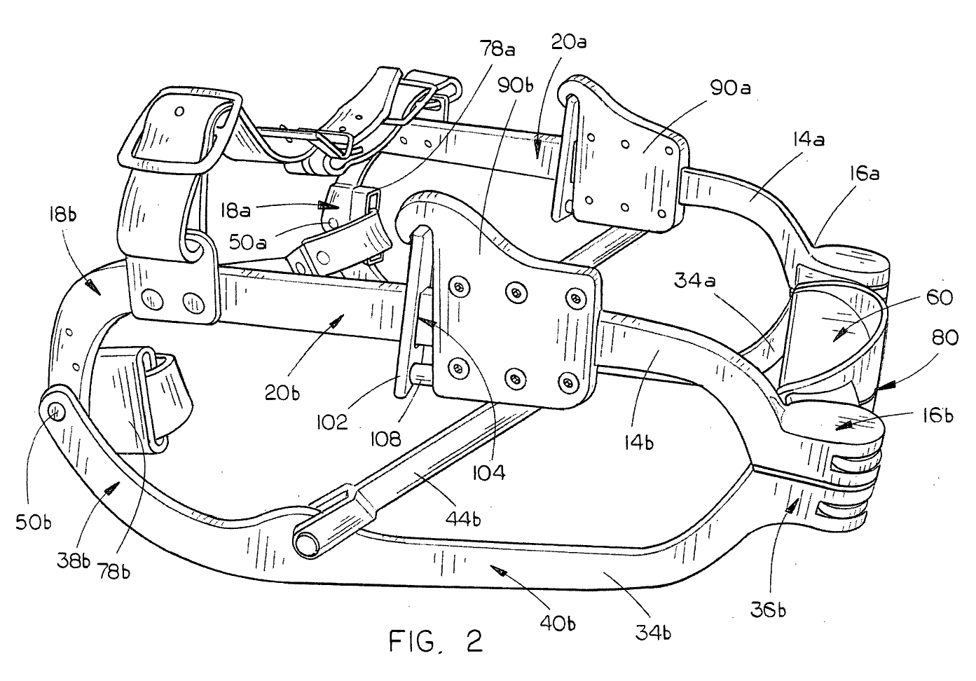

The improved equine dental speculum 10 of the present invention is shown best in FIGS. 1-4 as including an upper frame 12 and a lower frame 32, the upper frame 12 including left and right upper frame arms 14a and 14b which each include a forward end 16a and 16b, a rearward end 18a and 18b and a middle section 20a and 20b. Likewise, the lower frame 32 would preferably include left and right lower frame arms 34a and 34b each of which include a forward end 36a and 36b, rearward end 38a and 38b and a middle section 40a and 40b. It is preferred that the upper and lower frames 12 and 32 have lengths of approximately twelve to twenty-four inches, with the left and right upper and lower frame arms 14a, 14b, 34a, and 34b being constructed of a stainless steel material or the like in order to provide an easily sterilized and extremely durable construction material. Also, it is preferred that the upper and lower frames 12 and 32 have a generally elongated C-shape where the middle sections 20a, 20b, 40a, and 40b are generally straight and the forward and rearward ends of the left and right upper and lower frame arms 14a, 14b, 34a, and 34b are curved downwards and upwards, respectively, as shown best in FIGS. 1 and 2, although the exact shape of the left and right upper and lower frame arms 14a, 14b, 34a, and 34b is not particularly critical to the present invention so long as at least one pair of the middle sections 20a, 20b, 40a, and 40b are generally straight, for reasons which will become evident later in this disclosure.

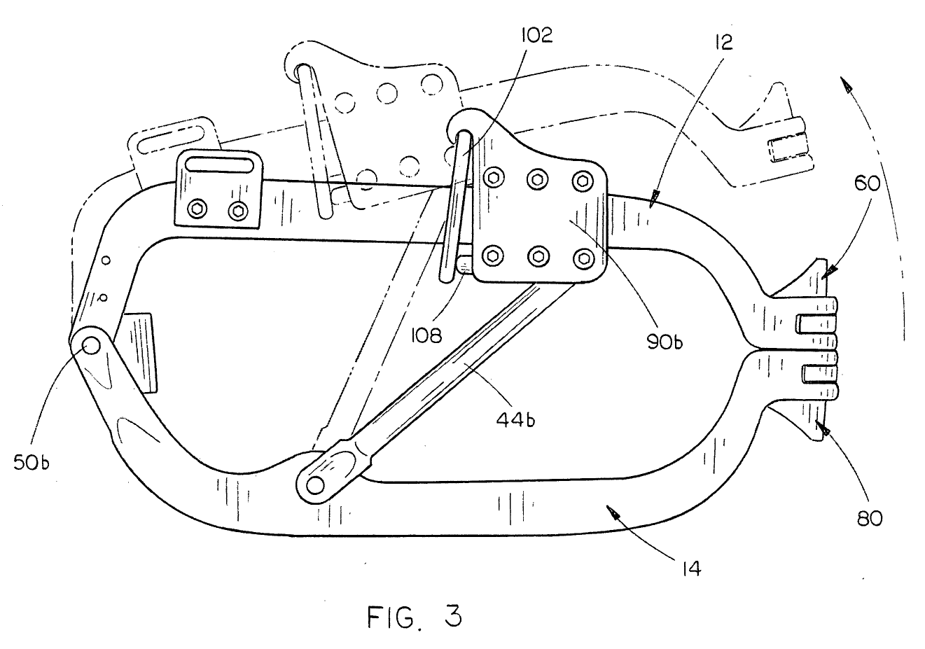

Upper and lower frames 12 and 32 are preferably pivotably connected to one another at the rearward ends 18a, 18b, 38a, and 38b of the left and right upper and lower frame arms 14a, 14b, 34a and 34b wherein the pivot joint 50a and 50b in each of the left and right upper and lower frame arms 14a, 14b, 34a, and 34b would include a pin-receiving hole 52a, 52b, 52c, and 52d which, when aligned as shown in FIGS. 2 and 3, will permit a pivot joint securement pin 54a and 54b to be extended through the aligned pivot joint pin-receiving holes 52a-d. Of course, other types of pivot joints may be used in connection with the present invention so long as the intended function of permitting the upper frame 12 to pivot relative to the lower frame 32, as shown in FIG. 3, is maintained.

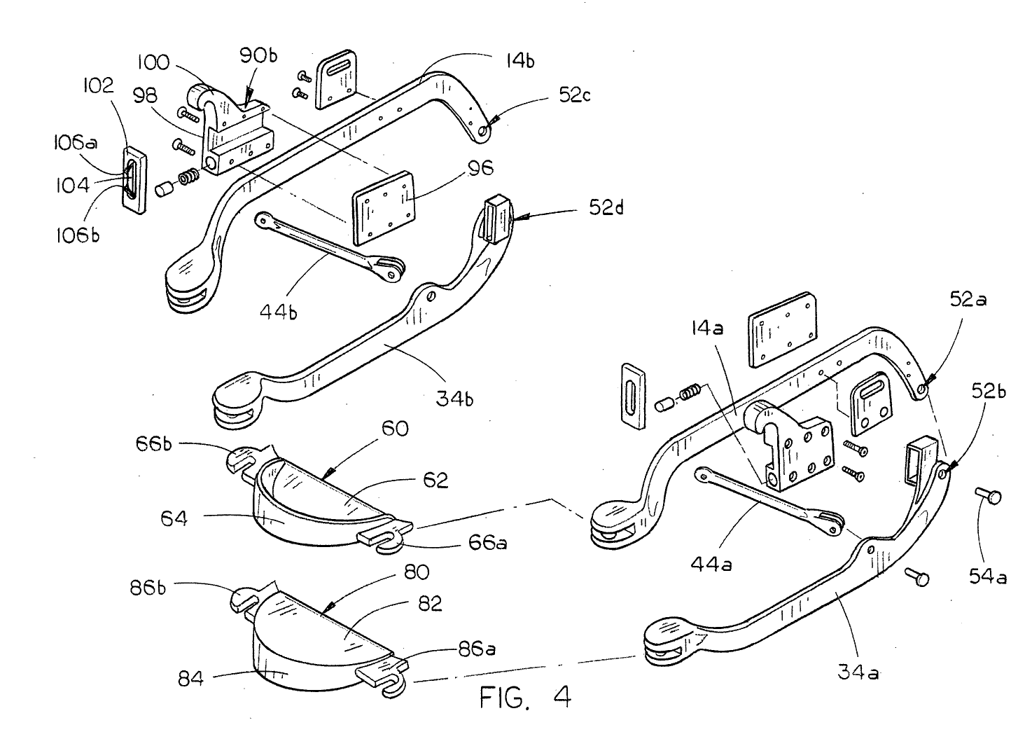

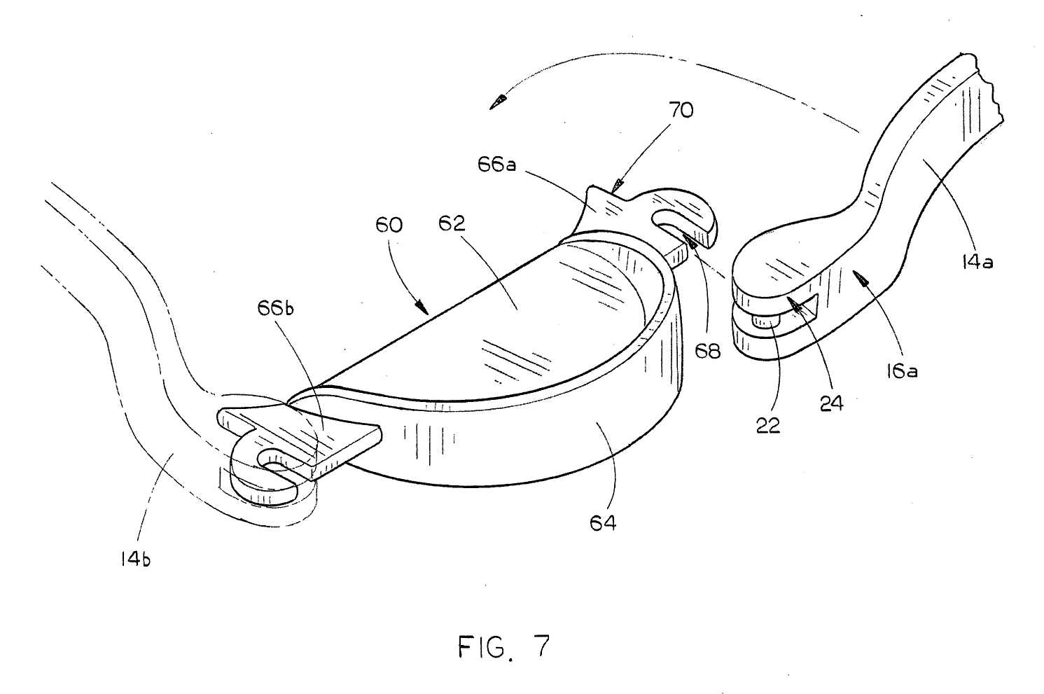

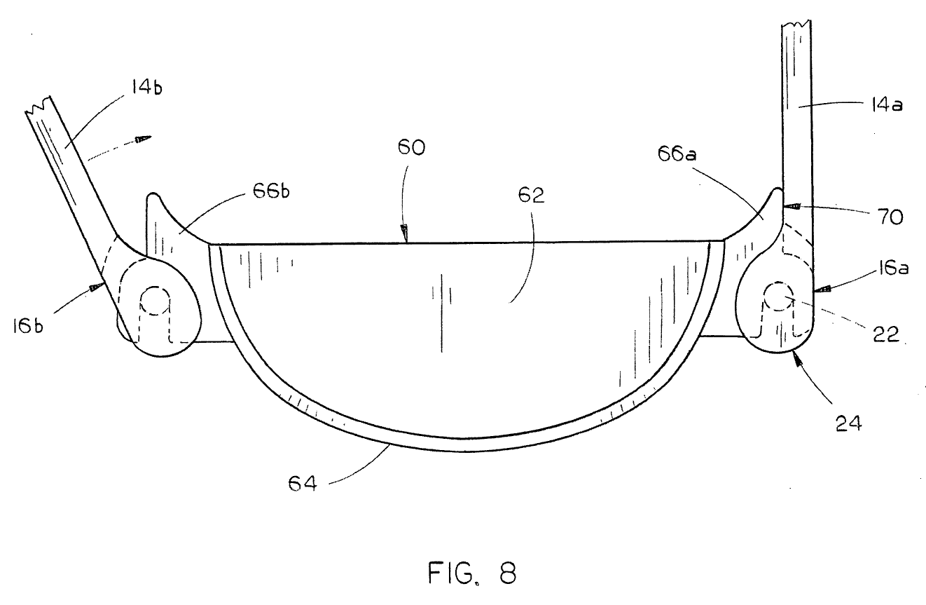

Extending between and releasably connecting the forward ends 16a and 16b of left and right upper frame arms 14a and 14b is an upper jaw and teeth engagement bar 60 which, in the preferred embodiment, would include a semi-circular upper bite plate 62 and an arcuate forward wall 64 extending around the forward circumference of the upper bite plate 62, as shown best in FIG. 4. In the preferred embodiment, the upper bite plate 62 would be generally semi-circular in shape and would be tilted downwards at an angle of approximately five to twenty-five degrees from horizontal (preferably at about fifteen degrees from horizontal) in order to better fit the incisors of the horse on which the upper jaw and teething engagement bar 60 is to be fitted. Also, mounted on opposite sides of the upper bite plate 62 are left and right upper frame arm engagement hooks 66a and 66b which are generally identical to one another and therefore the description of the left upper frame arm engagement hook 66a should be understood to apply equally to right upper frame arm engagement hook 66b. Left upper frame arm engagement hook 66a includes a forward pin-receiving notch 68 and a frame rotation stop shoulder 70 formed rearwards of the pin-receiving notch 68, the frame rotation stop shoulder 70 being a generally straight edge on the left upper frame arm engagement hook 66a which is angled outwards slightly from perpendicular with the upper bite plate 62 and which is operative to prevent rotation of the left upper frame arm 14a inwards towards the right upper frame arm 14b beyond a certain extent as permitted by the frame rotation stop shoulder 70 when it engages the left upper frame arm 14a. The connection between the left upper frame arm 14a and left upper frame arm engagement hook 66a is completed because the left upper frame arm 14a includes a forward engagement pin 22 which is mounted in an upright position between the arms of forward frame fork 24, as shown best in FIG. 7. The left upper frame arm 14a would be extended sideways relative to the upper jaw and teething engagement bar 60, as shown in FIG. 7, and the frame engagement pin 22 would be slid into pin-receiving notch 68. The left upper frame arm 14a would then be pivoted rearwardly until the left upper frame arm 14a engages frame rotation stop shoulder 70, at which time the left upper frame arm 14a is in the position shown best in FIG. 2 where it is ready to be placed on a horse for use therewith.

In a similar manner, extending between and connecting the left and right lower frame arms 34a and 34b at the forward ends 36a and 36b thereof is a lower jaw and teeth engagement bar 80 which also includes a lower bite plate 82, forward wall 84, and left and right lower frame arm engagement hooks 86a and 86b. The left and right lower frame arms 34a and 34b would be connected to the lower jaw and teeth engagement bar 80 in an identical manner as that described in connection with upper jaw and teeth engagement bar 60 and the frame rotation stop shoulders 70 found on both the upper and lower jaw and teeth engagement bars 60 and 80 will maintain proper spacing of the left and right upper and lower frame arms 14a, 14b, 34a, and 34b from each other when the improved equine dental speculum 10 of the present invention is placed on the horse's head, as shown in FIG. 1. This provides two benefits, the first being that the frame arms will not “squeeze” the horse's head when the securement straps are tightened down, as the opposite sides of the upper and lower frames 12 and 32 cannot pivot inwards beyond the angle defined by the frame rotation stop shoulders 70. Second, the maintenance of the proper spacing of the left and right upper and lower frame arms 14a, 14b, 34a, and 34b ensures proper operation of the improved equine dental speculum 10 of the present invention in that the upper and lower frames 12 and 32 may pivot relative to one another in their intended manner thereby generally eliminating improper alignment problems often encountered in using other prior art devices.

Another significant improvement over those devices found in the prior art provided by the present invention is that the present invention provides an improved frame spacing device which is operative to maintain the spacing of the upper and lower frames 12 and 32 relative to one another in a far more simple and straightforward manner. Specifically, the present invention provides left and right frame spacing securement devices 90a and 90b which act to secure the upper and lower frames 12 and 32 in a selected spaced position as the upper and lower frames 12 and 32 are pivoted apart from one another about pivot joints 50a and 50b. In the preferred embodiment, each of the left and right frame spacing securement devices 90a and 90b are generally identical to one another and therefore the description of right frame spacing securement device 90b should be understood to apply equally to left frame securement device 90a.

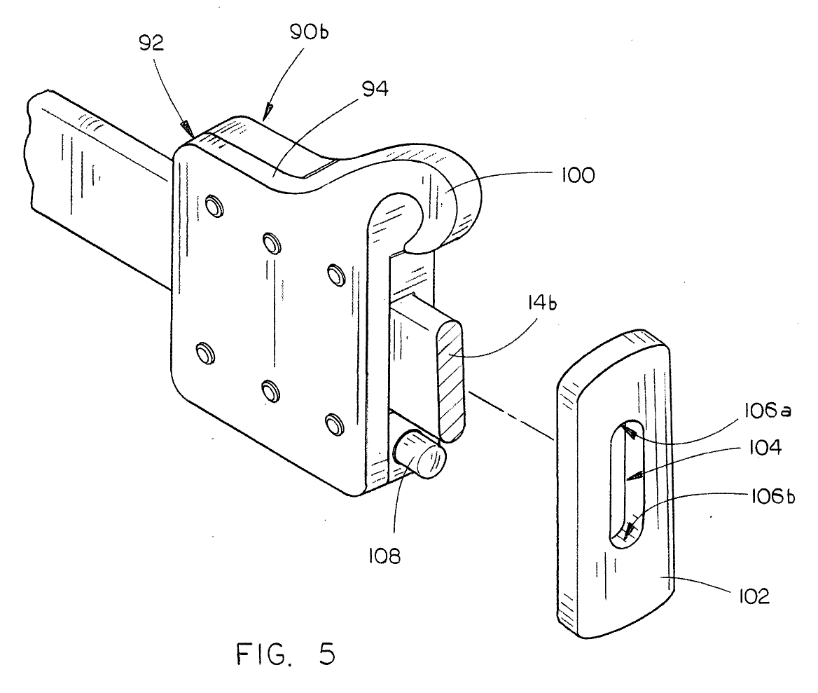

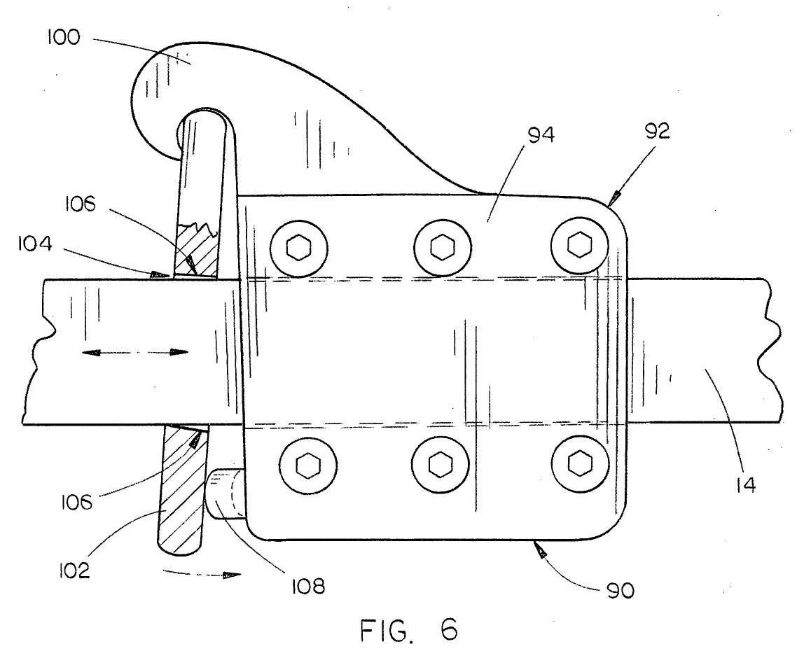

Right frame spacing securement device 90b is best shown in FIGS. 2, 4, 5, and 6 as including a slide stop assembly 92 including a carriage 94 slidably mounted on the middle section 20b of right upper frame arm 14b, the carriage 94 being generally rectangular in shape and including a left section 96 and right section 98 which are connected to one another in a position surrounding and enclosing the right upper frame arm 14b. In the preferred embodiment, the left and right sections 96 and 98 of carriage 94 would be secured to one another by bolts, screws or the like, and the inner passage of the left and right sections 96 and 98, when the carriage 94 is assembled, would be slightly larger than the cross-sectional shape of the right upper frame arm 14b, as shown best in FIGS. 5 and 6. It should be noted that in order to facilitate the sliding motion of the carriage 94 on right upper frame arm 14b, right upper frame arm 14b would preferably be generally rectangular in cross-sectional shape, but would include upper and lower rounded radii such that the right upper frame arm 14b has a cross-sectional shape of a rounded rectangle, as shown best in FIG. 5.

Mounted on and extending forwards from right section 98 of carriage 94 is a stop bar mounting hook 100 which engages and retains the stop bar 102 when the stop bar 102 is mounted on the right upper frame arm 14b, as shown best in FIG. 6. In the preferred embodiment, the stop bar 102 would be a generally rectangular metal bar having a frame arm slot 104 extending transversely therethrough with the frame arm slot 104 having a cross-sectional shape and dimensions slightly greater than the cross-sectional shape of the upper frame arm 14b on which it is mounted. As shown best in FIG. 6, when the stop bar 102 is mounted within the stop bar engagement hook 100, the stop bar engagement hook 100 permits the stop bar 102 to pivot slightly forwards and rearwards and because the frame arm slot 104 is of slightly greater height than the height of the right upper frame arm 14b, when the stop bar 102 is generally upright, the upper and lower edges 106a and 106b of the frame arm slot 104 do not frictionally engage the right upper frame arm 14b. However, when the stop bar 102 is biased away from the carriage 94, the upper and lower edges 106a and 106b of frame arm slot 104 do frictionally engage the right upper frame arm 14b, thus preventing the carriage 94 from moving forwards on the right upper frame arm 14b. This biasing of stop bar 102 away from the carriage 94 is accomplished via biasing pin 108 which extends forwards from the lower part of carriage 94, the biasing pin 108 being biased forwards by biasing spring 110, which is shown best in FIG. 4.

Therefore, carriage 94 is prevented from moving forwards on the right upper frame arm 14b when the stop bar 102 is forwardly biased via biasing pin 108 which causes upper and lower edges 106a and 106b of frame arm slot 104 to frictionally engage the right upper frame arm 14b. When the stop bar 102 is pivoted towards carriage 94 into a generally upright position, the frictional contact between the upper and lower edges 106a and 106b of frame arm slot 104 with right upper frame arm 14b is released and the carriage 94 may again move forwards on the right upper frame arm 14b.

Pivotably mounted on the middle sections 40a and 40b of left and right lower frame arms 34a and 34b are a pair of frame spacing bars 44a and 44b which extend upwards to pivotably connect to a respective one of the left and right frame spacing securement devices 90a and 90b, as shown best in FIGS. 2 and 3. It is these frame spacing bars 44a and 44b which securely space the upper and lower frames 12 and 32 from one another depending on the sliding location of the carriage 94 of the associated left and right frame spacing securement device 90a and 90b. Specifically, as the upper frame 12 and lower frame 32 are pivoted apart from one another, the left and right frame spacing securement devices 90a and 90b slide rearwards on the left and right upper frame arms 14a and 14b and the frame spacing bars 44a and 44b pivot along with the movement of the left and right frame spacing securement devices 90a and 90b. Likewise, as the left and right frame spacing securement devices 90a and 90b slide forwards on left and right upper frame arms 14a and 14b, the frame spacing bars 44a and 44b pivot to maintain the connection between the upper and lower frames 12 and 32 formed by the frame spacing bars 44a and 44b.

To securely mount the improved equine dental speculum 10 of the present invention on a horse 200, a pair of securement straps are mounted on the upper and lower frames 12 and 32, with there preferably being two securement straps, the first being an adjustable nose strap 74 mounted on and extending between a pair of brackets, one mounted on each of the left and right upper frame arms 14a and 14b of upper frame 12 and the second being an adjustable head strap 76 which is mounted on and connected to a pair of head strap connection slots 78a and 78b which are mounted on the upper frame 12 at the rearward ends 18a and 18b of left and right upper frame arms 14a and 14b, as shown best in FIGS. 1 and 2.

In operation, the improved equine dental speculum 10 of the present invention would be used in the following manner. First of all, the user would slide the device onto the horse 200 with the improved equine dental speculum 10 in the configuration shown best in FIG. 2 with the upper and lower frames 12 and 32 closed against one another. The upper and lower jaw and teeth engagement bars 60 and 80 would then be slid into the horse's mouth 202 with the upper jaw and teeth engagement bar 60, specifically upper bite plate 62, engaging the upper incisors of the horse 200 and the lower jaw and teeth engagement bar 80 engaging the lower incisors of the horse 200, as shown best in FIG. 1. The adjustable nose strap 74 and adjustable head strap 76 would then be secured on the horse's head and the improved equine dental speculum 10 of the present invention is thus ready for use.

As was discussed previously, one of the significant problems in performing equine dentistry is that horses generally have extremely powerful jaws and, because they are animals, it can be an exceedingly trying task to keep the horse's mouth open during the performing of the dental services. As the horse 200 opens its mouth, the present invention may be manually expanded to pivot the upper and lower frames 12 and 32 apart thus taking whatever jaw-opening movement the horse makes and retaining the relative position of the upper and lower frames 12 and 32 regardless of how large or small is the opening movement of the horse's mouth. This is accomplished because as the left and right frame spacing securement devices 90a and 90b slide rearwards on the left and right upper frame arms 14a and 14b, the frictional engagement of the frame arm slot 104, specifically the upper and lower edges 106a and 106b of frame arm slot 104 of the stop bar 102, permits the opening of the upper and lower frames 12 and 32 relative to one another, but the frictional engagement of the stop bar 102 with the left and right upper frame arms 14a and 14b prevents the movement of the left and right frame spacing securement devices 90a and 90b forwards on the left and right upper frame arms 14a and 14b unless the stop bar 102 is pivoted on stop bar engagement hook 100 to release the frictional engagement of the frame arm slot 104 with left and right upper frame arms 14a and 14b.

This means that as the upper and lower frames 12 and 32 are pivoted away from one another manually corresponding to the horse opening its mouth, it does not matter how much or how little that pivoting motion actually is, the present invention will retain that separational movement and prevent the horse 200 from closing its jaws any amount until the stop bar 102 of each of the left and right frame spacing securement devices 90a and 90b is released. Once the equine dentistry or other such task is performed, the present invention may be released simply by pivoting stop bar 102 on stop bar engagement hook 100 to a position generally perpendicular to the left and right upper frame arms 14a and 14b to release the frictional contact between the frame arm slot 104 and the left and right upper frame arms 14a and 14b thereby permitting the left and right frame spacing securement devices 90a and 90b to move forwards on the left and right upper frame arms 14a and 14b. Once the upper and lower frames 12 and 32 have been returned to their initial configuration shown best in FIG. 2, the improved equine dental speculum 10 of the present invention may be removed from the horse 200 simply by releasing the nose and head straps 74 and 76, and because the entire device is constructed of stainless steel, the entire device may be easily cleaned and sterilized in preparation for the next usage thereof.

It is to be understood that numerous additions, modifications and substitutions may be made to the improved equine dental speculum 10 of the present invention which fall within the intended broad scope of the appended claims. For example, the size, shape, and construction materials used in connection with the present invention may be modified or changed so long as the intended functional characteristics of the present invention are generally maintained. Also, although the upper and lower jaw and teeth engagement bars 60 and 80 have been described as including certain particular features which are designed to enhance their usefulness, the truly significant and critical features thereof are that the frame rotation stop shoulder 70 prevents overrotation of the left and right upper and lower frame arms 14a, 14b, 34a and 34b inwards toward one another which could adversely affect the performance and comfort of the improved equine dental speculum 10 of the present invention. Also, it should be noted that the left and right frame spacing securement devices 90a and 90b may be mounted on the lower frame arms 34a and 34b with the frame spacing bars 44a and 44b being mounted on the upper frame arms 14a and 14b, and the elements would function in a generally identical manner as described previously. Finally, although the present invention has been described for use in connection with horses and for use generally for equine dental purposes, it should be noted, of course, that it may be used for any purpose for which the device is suited, and it is expected that the present invention may be used with other types of livestock and for purposes other than equine dentistry.

There has therefore been shown and described an improved equine dental speculum 10 which accomplishes at least all of its intended objectives.

I claim:

1. An improved equine dental speculum comprising:
an upper frame having left and right upper frame arms each including a forward end, a rearward end and a middle section;
a lower frame having left and right lower frame arms each including a forward end, a rearward end and a middle section;
pivot joints pivotably joining said upper frame and said lower frame at said rearward ends of respective adjacent left and right frame arms;
an upper jaw and teeth engagement bar having an incisor engagement section, said upper jaw and teeth engagement bar extending between and releasably connecting the forward ends of said left and right upper frame arms;
a lower jaw and teeth engagement bar having an incisor engagement section, said lower jaw and teeth engagement bar extending between and releasably connecting the forward ends of said left and right lower frame arms;
at least one set of securement straps mounted on said equine dental speculum for releasably securing said equine dental speculum on a horse;
at least one frame spacing securement device including a slide stop assembly movably mounted on said middle section of one of said left and right upper and left and right lower frame arms, said slide stop assembly including a movably-mounted arm-engaging carriage and a stop bar adjustably mounted on said arm-engaging carriage, said stop bar having a frame arm slot extending transversely therethrough and having dimensions slightly larger than the cross-sectional dimensions of said frame arm on which said stop bar is mounted and through which said frame arm extends when said slide stop assembly is mounted thereon, said stop bar releasably frictionally engaging said frame arm on which said slide stop assembly is mounted;
a frame spacing bar extending from and pivotably connected to said middle section of one of said left and right upper and left and right lower frame arms on the same side as said slide stop assembly and on the opposite upper and lower frame arm;
said slide stop assembly operative to move in one direction on said frame arm on which it is mounted upon said upper and lower frames being pivoted apart from one another, said stop bar releasbly frictionally engaging said frame arm on which it is mounted to prevent said slide stop assembly from moving in the opposite direction until and unless said stop bar is pivoted to release the frictional contact between said frame arm and said frame arm slot of said stop bar whereby said upper and lower frames are prevented from moving towards one another.

2. The improved equine dental speculum of claim 1 further comprising a frame rotation stop shoulder formed on each of said upper jaw and teeth engagement bar and said lower jaw and teeth engagement bar, said frame rotation stop shoulder operative to restrict rotation of said left and right upper and lower frame arms inwards towards one another beyond a certain extent due to engagement of said frame rotation stop shoulders with said left and right upper and lower frame arms.

3. The improved equine dental speculum of claim 1 wherein said upper and lower frames are constructed of stainless steel.

4. The improved equine dental speculum of claim 1 wherein said upper jaw and teeth engagement bar further comprises a semi-circular upper bite plate and an arcuate forward wall extending around the forward circumference of the upper bite plate.

5. The improved equine dental speculum of claim 4 wherein said upper bite plate is tilted downwards at an angle of approximately five to twenty-five degrees (5° to 25°) from horizontal in order to better fit the incisors of the horse.

6. The improved equine dental speculum of claim 1 wherein said lower jaw and teeth engagement bar further comprises a semi-circular lower bite plate and an arcuate forward wall extending around the forward circumference of the lower bite plate.

7. The improved equine dental speculum of claim 1 comprising two frame spacing securement devices, one mounted on each side of one of said upper and lower frames.

8. The improved equine dental speculum of claim 1 wherein said slide stop assembly of said at least one frame spacing securement device includes a biasing means operatively connected to said stop bar to pivot said stop bar into a frictionally engaging position relative to said frame arm on which said stop bar is mounted, said biasing means being releasable to permit said stop bar to pivot to a generally frictionally non-engaging position generally perpendicular to said frame arm.

9. The improved equine dental speculum of claim 1 wherein said slide stop assembly comprises a carriage slidably mounted on said middle section of one of said frame arms, said carriage being generally rectangular in shape and including a left section and right section which are connected to one another in a position surrounding and enclosing said frame arm on which said slide stop assembly is mounted.

10. The improved equine dental speculum of claim 9 wherein said slide stop assembly further comprises a stop bar mounting hook operative to engage and retain said stop bar when said stop bar is mounted on a selected one of said frame arms.

11. An improved equine dental speculum comprising:
an upper frame having left and right upper frame arms each including a forward end, a rearward end and a middle section;
a lower frame having left and right lower frame arms each including a forward end, a rearward end and a middle section;
pivot joints pivotably joining said upper frame and said lower frame at said rearward ends of respective adjacent left and right frame arms;
an upper jaw and teeth engagement bar having an incisor engagement section, said upper jaw and teeth engagement bar extending between and releasably connecting the forward ends of said left and right upper frame arms;
a lower jaw and teeth engagement bar having an incisor engagement section, said lower jaw and teeth engagement bar extending between and releasably connecting the forward ends of said left and right lower frame arms;
at least one set of securement straps mounted on said equine dental speculum for releasably securing said equine dental speculum on a horse;
at least one frame spacing securement device including a slide stop assembly movably mounted on said middle section of one of said left and right upper and left and right lower frame arms, said slide stop assembly including a movably-mounted arm-engaging carriage and a stop bar adjustably mounted on said arm-engaging carriage, said stop bar having a frame arm slot extending transversely therethrough and having dimensions slightly larger than the cross-sectional dimensions of said frame arm on which said stop bar is mounted and through which said frame arm extends when said slide stop assembly is mounted thereon, said stop bar releasably frictionally engaging said frame arm on which said slide stop assembly is mounted;
a frame spacing bar extending from and pivotably connected to said middle section of one of said left and right upper and left and right lower frame arms on the same side as said slide stop assembly and on the opposite upper and lower frame arm;
said slide stop assembly operative to move in one direction on said frame arm on which it is mounted upon said upper and lower frames being pivoted apart from one another, said stop bar releasbly frictionally engaging said frame arm on which it is mounted to prevent said slide stop assembly from moving in the opposite direction until and unless said stop bar is pivoted to release the frictional contact between said frame arm and said frame arm slot of said stop bar whereby said upper and lower frames are prevented from moving towards one another; and
a frame rotation stop shoulder formed on each of said upper jaw and teeth engagement bar and said lower jaw and teeth engagement bar, said frame rotation stop shoulder operative to restrict rotation of said left and right upper and lower frame arms inwards towards one another beyond a certain extent due to engagement of said frame rotation stop shoulders with said left and right upper and lower frame arms.

12. The improved equine dental speculum of claim 11 wherein said upper and lower frames are constructed of stainless steel.

13. The improved equine dental speculum of claim 11 wherein said upper jaw and teeth engagement bar further comprises a semi-circular upper bite plate and an arcuate forward wall extending around the forward circumference of the upper bite plate.

14. The improved equine dental speculum of claim 13 wherein said upper bite plate is tilted downwards at an angle of approximately five to twenty-five degrees (5° to 25°) from horizontal in order to better fit the incisors of the horse.

15. The improved equine dental speculum of claim 11 wherein said lower jaw and teeth engagement bar further comprises a semi-circular lower bite plate and an arcuate forward wall extending around the forward circumference of the lower bite plate.

16. The improved equine dental speculum of claim 11 comprising two frame spacing securement devices, one mounted on each side of one of said upper and lower frames.

17. The improved equine dental speculum of claim 11 wherein said slide stop assembly of said at least one frame spacing securement device includes a biasing means operatively connected to said stop bar to pivot said stop bar into a frictionally engaging position relative to said frame arm on which said stop bar is mounted, said biasing means being releasable to permit said stop bar to pivot to a generally frictionally non-engaging position generally perpendicular to said frame arm.

18. The improved equine dental speculum of claim 11 wherein said slide stop assembly comprises a carriage slidably mounted on said middle section of one of said frame arms, said carriage being generally rectangular in shape and including a left section and right section which are connected to one another in a position surrounding and enclosing said frame arm on which said slide stop assembly is mounted.

19. The improved equine dental speculum of claim 18 wherein said slide stop assembly further comprises a stop bar mounting hook operative to engage and retain said stop bar when said stop bar is mounted on a selected one of said frame arms.

20. An improved equine dental speculum comprising:
an upper frame having left and right upper frame arms;
a lower frame having left and right lower frame arms;
said upper and lower frames pivotably connected to one another at the rearward ends thereof;
an upper jaw and teeth engagement bar extending between and releasably connecting said left and right upper frame arms at the forward ends thereof;
a lower jaw and teeth engagement bar extending between and releasably connecting said left and right lower frame arms at the forward ends thereof;
at least one set of securement straps mounted on said equine dental speculum for releasably securing said equine dental speculum on a horse;
at least one frame spacing securement device including a slide stop assembly movably mounted on one of said left and right upper and left and right lower frame arms, said slide stop assembly including a carriage and a stop bar adjustably mounted on said carriage, said stop bar having a frame arm slot extending transversely therethrough and having dimensions slightly larger than the cross-sectional dimensions of said frame arm on which said stop bar is mounted and through which said frame arm extends when said slide stop assembly is mounted thereon, said stop bar movable between a frictionally engaging position and a non-frictionally engaging position with said frame arm on which said slide stop assembly is mounted;
a frame spacing bar extending from and pivotably connected to one of said left and right upper and left and right lower frame arms on the same side as said slide stop assembly and on the opposite upper and lower frame arm;
said slide stop assembly operative to move in one direction on said frame arm on which it is mounted upon said upper and lower frames being pivoted apart from one another, said stop bar releasbly frictionally engaging said frame arm on which it is mounted to prevent said slide stop assembly from moving in the opposite direction until and unless said stop bar is pivoted to release the frictional contact between said frame arm and said frame arm slot of said stop bar whereby said upper and lower frames are prevented from moving towards one another; and
at least one frame rotation stop shoulder formed on each of said upper jaw and teeth engagement bar and said lower jaw and teeth engagement bar, said frame rotation stop shoulders operative to restrict rotation of said left and right upper and lower frame arms inwards towards one another beyond a certain extent due to engagement of said frame rotation stop shoulders with said left and right upper and lower frame arms.
